(19) United States
(12) Patent Application Publication
(10) Pub. No.: US 2008/0130167 A1
(43) Pub. Date: Jun. 5, 2008

(54) Information storage device

(75) Inventor: Keishi Shimizu, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/004,326

(22) Filed: Dec. 20, 2007

Related U.S. Application Data
(63) Continuation of application No. PCT/JP2005/012058, filed on Jun. 30, 2005.

(51) Int. Cl. G11B 33/14

(52) U.S. Cl. 360/97.02

(57) ABSTRACT

The present invention aims to provide an information storage device realizing high cleaning performance. The information storage device includes: a plurality of disc-shaped information storage media that are rotated by being fixed to a common rotary shaft and record information, and in each of which through holes penetrating the disc-shaped medium are formed around the rotary shaft; an access section that accesses information in the information recording media; and a filter that removes dusts in air by passage of the air flowing in association with rotation of the information recording media.

This is a continuation filed under 35 U.S.C. § 111(a), of International Application No. PCT/JP2005/012058, filed Jun. 30, 2005.

### TECHNICAL FIELD

The present invention relates to an information storage device for accessing information in a disc-shaped information storage medium.

### BACKGROUND ART

In recent years, with widespread use of computers, a large amount of information is dealt with routinely. Such information is usually recorded as a number of physical marks on an information storage medium and is accessed by an information storage device mediating between the marks on the information storage medium and electric reproduction/recording signals.

As a representative information storage device, a magnetic disk drive is known. A magnetic disk drive usually has plural magnetic disks as information storage media in order to increase the storage capacity. The plural magnetic disks are fixed to a common rotary shaft at intervals in parallel with each other and rotated by the driving of the rotary shaft. Information is stored on both sides of a magnetic disk and accessed by a magnetic head which is moved close to both sides of the rotating magnetic disk.

In the magnetic disk drive, air current is generated in association with the rotation of the magnetic disk. A filter is fixed in a position where the air current passes. Clean air having passed through the filter flows along both sides of the magnetic disk. By the air current, both sides of the magnetic disk are cleaned (refer to Patent Documents 1 and 2).

Patent Document 1: Japanese Unexamined Patent Application Publication No. 2005-18937

Patent Document 2: Japanese Unexamined Patent Application Publication No. 61-208690

The recording density of magnetic disks is increasing year after year. With decrease in the flying amount of a flying head slider due to improvement in the recording density, higher performance is required also for the cleaning of disk faces. To obtain high cleaning performance, it is important to uniformly supply clean air to both sides of a magnetic disk. The air current is generated by friction between both sides of a magnetic disk and air. Consequently, the flow of air existing between two magnetic disks is strong, and the flow of air existing between a magnetic disk and a drive casing is weak. Therefore, a negative pressure area is strongly generated between neighboring magnetic disks, and the clean air from the filter is excessively concentrated on the area between the magnetic disks due to the negative pressure. There is a possibility that the surface of the magnetic disk facing the drive casing is insufficiently cleaned.

Patent Documents 1 and 2 disclose a magnetic disk drive in which an air passage is provided in a rotary shaft to which magnetic disks are fixed, and provide a technique of eliminating pool of air by allowing air to pass through the air passage. It is, however, difficult to provide such a structure to the rotary shaft of magnetic disks under present circumstances where the drive is becoming smaller and the cost is being lowered.

Such a problem occurs not only in magnetic disk drives but generally occurs in an information storage device of a type having plural disc-shaped information storage media and cleaning disk faces with air current generated by the rotation of the information storage media.

### DISCLOSURE OF THE INVENTION

In view of the circumstances, an object of the present invention is to provide an information storage device realizing high cleaning performance.

An information storage device of the present invention achieving the object includes: plural disc-shaped information storage media that are rotated by being fixed to a common rotary shaft and record information, and in each of which through holes penetrating the disc-shaped medium are formed around the rotary shaft; an access section that accesses information in the information recording media; and a filter that removes dusts in air by passage of the air flowing in association with rotation of the information recording media.

In the information storage device according to the present invention, typically, information is recorded in a band-shaped area surrounding the rotary shaft, in the disk surface of the information storage medium, and the through holes are formed in the inner side of the band-shaped area.

In the information storage device of the present invention, the air flows via the through holes formed in the information storage medium. Therefore, non-uniformity of the negative pressure between the disk faces as described above is eliminated. The clean air from the filter flows uniformly to the disk faces, so that high cleaning performance is achieved. Since the structure is simple, the invention can also cope with reduction in the size and cost of the information storage device.

In the information storage device according to the present invention, the through holes may be formed in one round around the rotary shaft or in plural rounds around the rotary shaft in the information storage medium.

In the information storage device according to the present invention, a circular hole may be formed as the through hole or a square hole with rounded corners may be formed as the through hole in the information storage medium.

Preferably, the information storage device according to the present invention further includes a ring-shaped spacer surrounding the rotary shaft, sandwiched by the plural information storage media, and maintaining an interval between the plural information storage media, in which a groove that extends in the direction of connecting the information storage media is formed in a position corresponding to the through hole.

In the information storage device having such a spacer, the positions of the through holes can be extended to the inner side to overlap the groove formed in the spacer. Thus, while sufficiently assuring the area for recording in the information storage medium, a sufficiently large through hole can be formed. An effect that air flows smoothly along the groove is also expected.

In the information storage device in such a mode, in the spacer, a round-bottomed groove, a flat-bottomed groove, or a V-shaped groove may be formed as the groove.

As described above, according to the present invention, the information storage device realizing high cleaning performance can be obtained.

### BRIEF DESCRIPTION OF THE DRAWINGS

FIG. 1 is a schematic configuration diagram showing an embodiment of the present invention.

FIG. 2 is a diagram showing the structure of a magnetic disk.

FIG. 3 is a diagram showing the positional relation between a magnetic disk and a spacer.

FIG. 4 is a diagram showing a pressure distribution of air on the lowermost layer which is in contact with the lowermost face of stacked magnetic disks in a comparative example.

FIG. 5 is a diagram showing a pressure distribution of air on an intermediate layer in stacked magnetic disks in the comparative example.

FIG. 6 is a diagram showing a pressure distribution of air on the lowermost layer which is in contact with the lowermost face of stacked magnetic disks in the magnetic disk drive of the embodiment.

FIG. 7 is a diagram showing a pressure distribution of air on an intermediate layer sandwiched by stacked magnetic disks in the magnetic disk drive of the embodiment.

FIG. 8 is a diagram showing variations in the shape of a through hole.

FIG. 9 is a diagram showing variations in the shape of a groove.

### BEST MODE FOR CARRYING OUT THE INVENTION

An embodiment of the present invention will be described below with reference to the drawings.

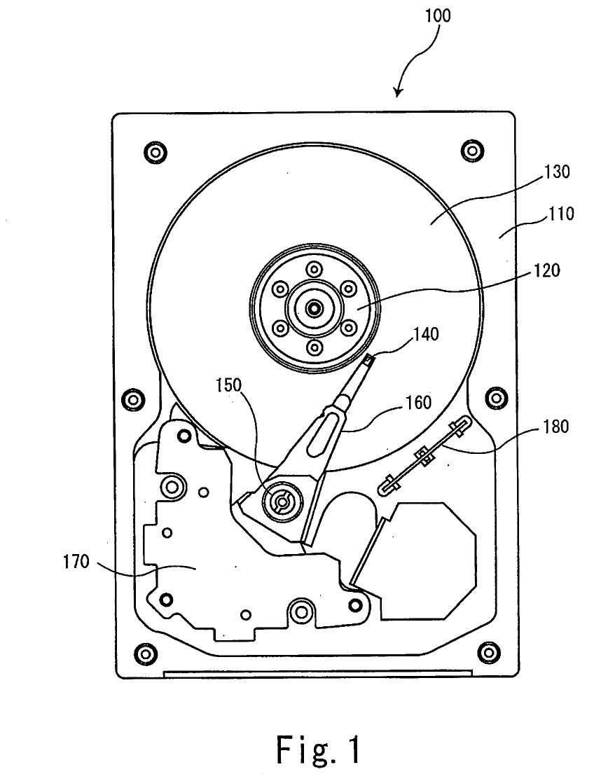

FIG. 1 is a schematic configuration diagram showing an embodiment of the present invention.

FIG. 1 shows a magnetic disk drive 100 corresponding to an embodiment of the present invention. A housing 110 of the magnetic disk drive 100 houses a rotary shaft 120, a magnetic disk 130 attached to the rotary shaft 120, a flying head slider 140 closely facing the surface of the magnetic disk 130, a carriage arm 160, tip of which the flying head slider 140 is fixed to and which moves along the disk surface of the magnetic disk 130 around an arm shaft 150 as a center, and an actuator 170 for driving the carriage arm 160. The internal space of the housing 110 is closed with a not-shown cover. In the embodiment, plural magnetic disks 130 are housed, fixed to the common single rotary shaft 120, and stacked at intervals.

The magnetic disk drive 100 records information to the magnetic disk 130 and reproduces information recorded on the magnetic disk 130. At the time of recording/reproducing information, the carriage arm 160 is driven by the actuator 170 constructed of a magnetic circuit, and the flying head slider 140 is positioned at a desired track on the magnetic disk 130 rotated by the driving of the rotary shaft 120. On the flying head slider 140, a not-shown magnetic head is mounted. The magnetic head is sequentially moved close to 1-bit areas arranged in each of the tracks of the magnetic disk 130 by the rotation of the magnetic disk 130 to access information recorded by means of magnetic fields on the 1-bit areas. Therefore, the information storage area on the magnetic disk 130 is a band-shaped area surrounding the rotary shaft 120.

The housing 110 of the magnetic disk drive 100 is also provided with a filter 180. Air current generated in association with rotation of the magnetic disk 130 passes through the filter 180, thereby obtaining clean air. With the flow of the clean air, the disk faces of the magnetic disks 130 are cleaned. The air existing between the plural magnetic disks 130 in a stacked state is driven by the rotation of the two disk faces sandwiching the air and thus, the air flow force between the magnetic disks 130 is strong. In contrast, the air in contact with the uppermost and lowermost faces of the stacked magnetic disks 130 is driven only by one disk face and thus, the driving force applied to the air by the disk face is weak. In the magnetic disk drive 100, however, the magnetic disk 130 is devised so that the air which is in contact with the uppermost and lowermost faces of the stacked magnetic disks 130 sufficiently flows.

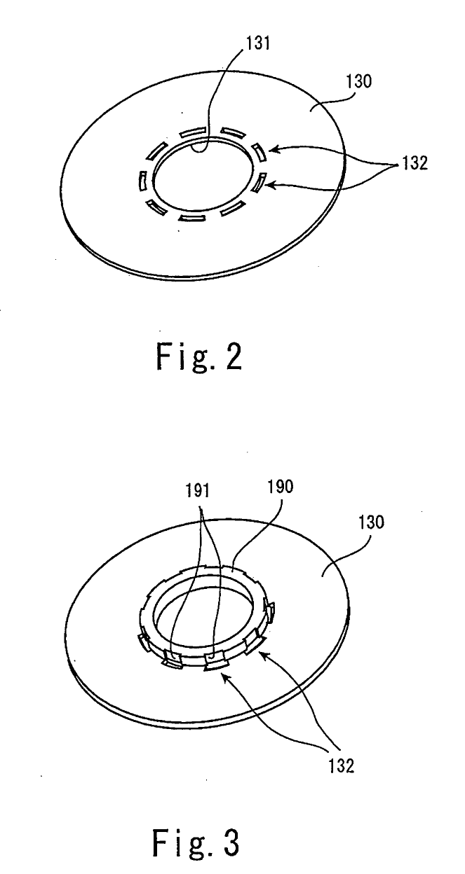

FIG. 2 is a diagram showing the structure of the magnetic disk 130.

A center hole 131 in which the rotary shaft 120 is to be inserted is formed in the center of the magnetic disk 130. Around the center hole 131 (that is, around the rotary shaft 120), nine through holes 132 penetrating the magnetic disk 130 are formed. The through holes 132 are formed on the inner side of the innermost radius of the information storage area on the magnetic disk 130.

As described above, plural magnetic disks 130 are provided in the magnetic disk drive 100 shown in FIG. 1 and spacers for maintaining the intervals are provided between neighboring magnetic disks 130.

FIG. 3 is a diagram showing the positional relation between the magnetic disk 130 and a spacer.

A spacer 190 is in the shape of a ring surrounding the rotary shaft 120 shown in FIG. 1. In the outer peripheral face of the spacer 190, grooves 191 are formed impositions corresponding to the through holes 132 in the magnetic disk 130. The through holes 132 are formed in positions that extent slightly inner than the outer peripheral face of the spacer 190. The open ratio of the through holes 132 is 50% in an area of 2 mm around the spacer 190.

The grooves 191 in the spacer 190 extend along two magnetic disks 130 sandwiching the spacer 190 so as to connect the two magnetic disks 130 and also connecting the respective sets of through holes 132 formed in the two magnetic disks 130.

Since the through holes 132 are formed in the magnetic disk 130 as described above, the air flows via the through holes 132. In addition, through the grooves 191 in the spacer 190, the air passing through the through holes 132 smoothly flows. As a result, as will be described later, the flow of sufficient air is generated on both of the uppermost and lowermost faces of stacked magnetic disks 130, and high cleaning performance can be obtained.

The effect of forming the through holes 132 in the magnetic disk 130 will be described with a comparative example. The comparative example relates to an information storage device similar to that of the embodiment except that magnetic disks having no through holes are used.

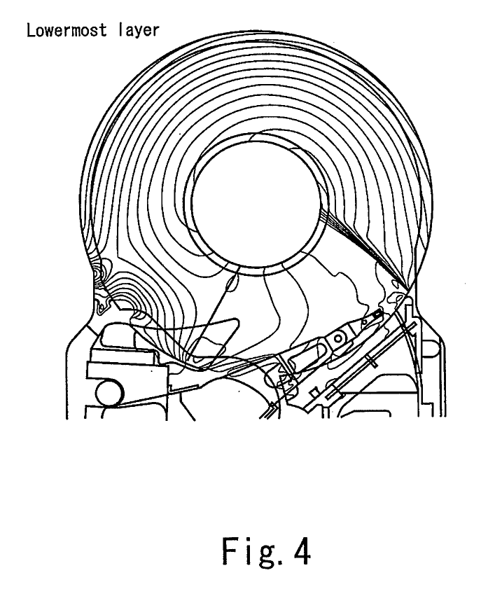

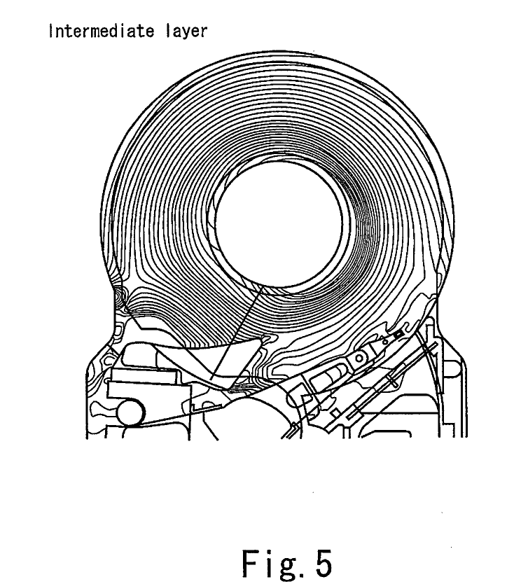

FIG. 4 is a diagram showing a pressure distribution of air in the lowermost layer which is in contact with the lowermost face of stacked magnetic disks in the comparative example. FIG. 5 is a diagram showing a pressure distribution of air in the intermediate layer sandwiched by the stacked magnetic disks in the comparative example.

In the comparative example, a large pressure gradient occurs in the intermediate layer. Due to the pressure gradient, a negative pressure area is generated around the rotary shaft in the intermediate layer. On the other hand, only a small pressure gradient is generated in the air of the lowermost layer, so that a large negative pressure area is not generated. As a result, the clean air obtained via the filter is strongly attracted by the intermediate layer. In the lowermost layer, the flow of clean air is insufficient and the face may not be cleaned enough.

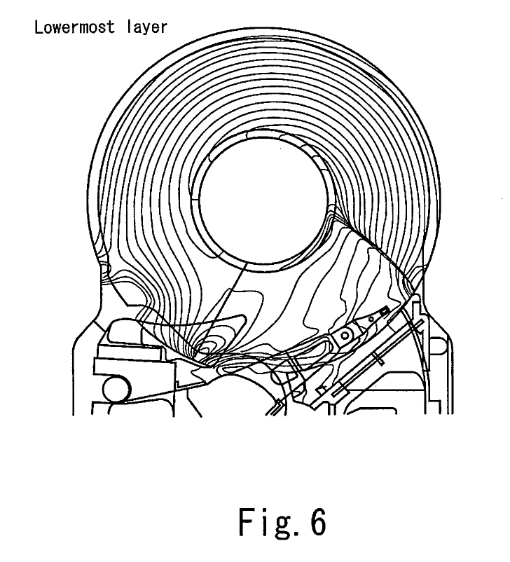

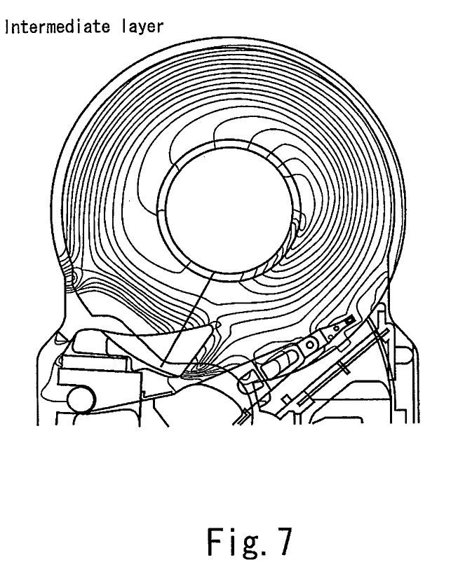

FIG. 6 is a diagram showing a pressure distribution of air in the lowermost layer which is in contact with the lowermost face of stacked magnetic disks in the magnetic disk drive of the embodiment illustrated in FIG. 1. FIG. 7 is a diagram showing a pressure distribution of air on an intermediate layer sandwiched by stacked magnetic disks in the magnetic disk drive of the embodiment.

In each of the magnetic disks in the embodiment, the above-described through holes are formed around the center shaft, and air flows via the through holes. As a result, there is hardly any difference between the pressure gradient in the lowermost layer and the pressure gradient in the intermediate layer, air cleaned via the filter flows uniformly on each of the disk faces, and the flow of sufficient air is generated on both of the uppermost and lowermost faces of the stacked magnetic disks. Therefore, the cleaning performance in the embodiment is high.

Variations of the shape in the through hole in the magnetic disk and the groove in the spacer will be described hereinbelow.

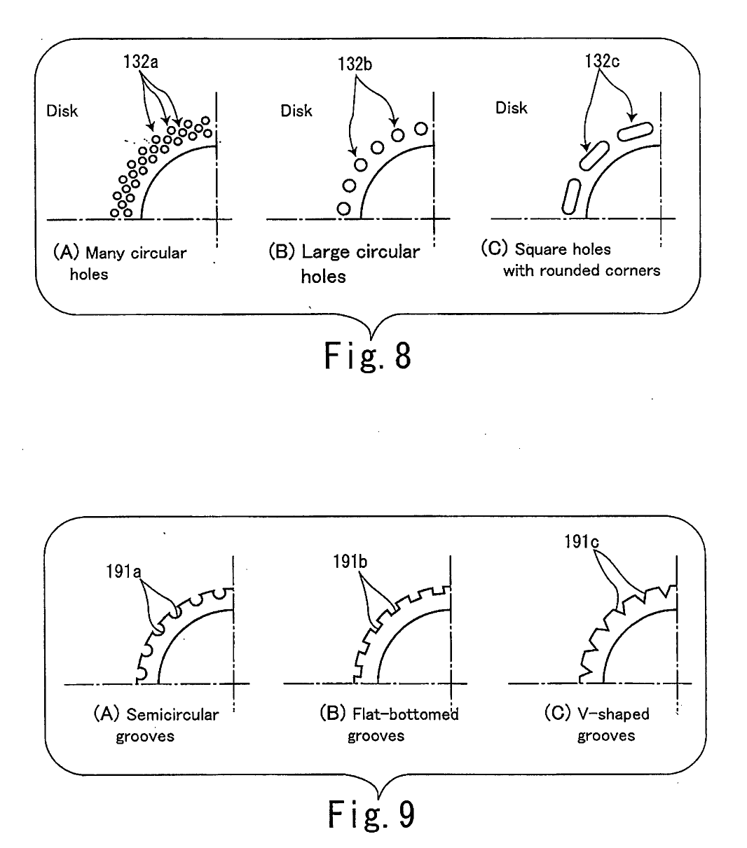

FIG. 8 is a diagram showing variations of the shape of the through hole.

Examples of the through holes formed in a magnetic disk are circular-shaped through holes 132a and 132b as shown in parts (A) and (B) in FIG. 8, respectively, and through holes 132c each having a square shape with rounded corners as shown in part (C) in FIG. 8. The throughholes of any shapes can be employed for the embodiment of the invention. Plural rounds of through holes maybe formed around the center shaft as shown in part (A) of FIG. 8, or only one round of through holes may be provided around the center shaft as shown in parts (B) and (C) in FIG. 8.

In the case where a number of circular-shaped small through holes 132a are formed as shown in part (A) in FIG. 8, as the groove in the spacer, a groove sufficiently larger than the through hole can be employed. There is an advantage that positioning between through holes and grooves at the time of assembling the device is unnecessary.

In the case where a small number of large circular-shaped through holes 132b are formed as shown in part (B) in FIG. 8, there is an advantage that the number of processes for forming through holes is small.

In the case where the through holes 132c each having a square shape with rounded corners as shown in part (C) in FIG. 8 are formed, there is an advantage that the through holes of the high open ratio can be easily obtained.

FIG. 9 is a diagram showing variations of the shape of the groove.

As the groove formed in the spacer, a round-bottomed groove 191a as shown in part (A) in FIG. 9, a flat-bottomed groove 191b as shown in part (B) in FIG. 9, a V-shaped groove 191c as shown in part (C) in FIG. 9, or the like can be considered. A groove having any shape can be employed for the embodiment of the invention.

The round-bottomed groove 191a as shown in part (A) in FIG. 9 has an advantage that processing is easy.

The flat-bottomed groove 191b as shown in part (B) in FIG. 9 has an advantage that the air passage area is large.

Since the contact area between the magnetic disk and the spacer is large in the case of forming the V-shaped groove 191c as shown in part (C) in FIG. 9, there is an advantage that the magnetic disk and the spacer can be firmly fastened and assembled.

As described above, each of the variations of the through hole and the groove has an advantage. It is expected that the high cleaning performance is obtained in the embodiment employing any of the variations.

In the embodiment, a magnetic disk is used as an example of the information storage medium in the present invention. The information storage medium in the present invention may be any of other disc-shaped storage media such as a magneto-optical disk.

What is claimed is:

1. An information storage device comprising:
a plurality of disc-shaped information storage media that are rotated by being fixed to a common rotary shaft and record information, and in each of which through holes penetrating the disc-shaped medium are formed around the rotary shaft;
an access section that accesses information in the information recording media; and
a filter that removes dusts in air by passage of the air flowing in association with rotation of the information recording media.

2. The information storage device according to claim 1, wherein information is recorded in a band-shaped area surrounding the rotary shaft, in a disk surface of the information storage medium, and the through holes are formed in the inner side of the band-shaped area.

3. The information storage device according to claim 1, wherein the through holes are formed in one round around the rotary shaft in the information storage medium.

4. The information storage device according to claim 1, wherein the through holes are formed in a plurality of rounds around the rotary shaft in the information storage medium.

5. The information storage device according to claim 1, wherein a circular hole is formed as the through hole in the information storage medium.

6. The information storage device according to claim 1, wherein a square hole with rounded corners is formed as the through hole in the information storage medium.

7. The information storage device according to claim 1, further comprising a ring-shaped spacer surrounding the rotary shaft, sandwiched by the plurality of information storage media, and maintaining an interval between the plurality of information storage media, in which a groove that extends in a direction of connecting the information storage media is formed in a position corresponding to each of the through holes.

8. The information storage device according to claim 6, wherein a round-bottomed groove is formed as the groove in the spacer.

9. The information storage device according to claim 6, wherein a flat-bottomed groove is formed as the groove in the spacer.

10. The information storage device according to claim 6, wherein a V-shaped groove is formed as the groove in the spacer.
